(19) United States
(12) Patent Application Publication
(10) Pub. No.: US 2018/0128347 A1
(43) Pub. Date: May 10, 2018

(54) DEVICE WITH A RECIPROCATING MOTION MECHANISM ENABLING THE CONVERSION OF ITS MOMENT OF INERTIA INTO ROTATIONAL SPEED OR ROTATIONAL SPEED INTO MOMENT OF INERTIA

(71) Applicant: CONTISSI Spólka z ograniczona odpowiedzialnoscia, Debica (PL)

(72) Inventor: Piotr CHUPTYS, Debica (PL)

(73) Assignee: CONTISSI Spólka z ograniczona odpowiedzialnoscia, Debica (PL)

(21) Appl. No.: 15/804,119

(22) Filed: Nov. 6, 2017

(30) Foreign Application Priority Data
Nov. 7, 2016 (PL) P.419376

(51) Int. Cl. F16F 15/31; F16H 9/20

(52) U.S. Cl. CPC F16F 15/31; B26D 5/12; F16H 9/20

(57) ABSTRACT

The subject of the invention is a device with a reciprocating motion mechanism enabling the conversion of its moment of inertia into rotational speed or rotational speed into moment of inertia, characterised in that on the rotating shaft (11) there is a releasable mechanism (2) of reciprocating motion in two perpendicular directions, including two circular discs (3 and 4), tiled in parallel, with profiled notches (7 and 8) on their surfaces, whereby both discs are connected with each other by bolts (10) and have a releasable connection with the rotating shaft (11) and between each pair of profiled notches (7 and 8) of both discs there are upper connectors (14) of the upper ends of each pair of opposite moving arms (15), having an articulated connection with each other, of which the other ends also have an articulated connection with the two ring connectors (17) of two hydraulic actuators (18), which have a releasable connection with this shaft, whereby all upper connectors are equipped with functional components (22) placed on them and having a releasable connection with them.

### FIELD OF THE INVENTION

The subject of this invention is a device with a reciprocating motion mechanism enabling the conversion of its moment of inertia into rotational speed, which finds application in machine and facility drives, as well as in cars with combustion and electrical engines, in particular as variators, vibration dampers and energy banks.

### BACKGROUND OF THE PRIOR ART

In known systems that convert reciprocating motion into rotary motion, balancing the forces of inertia for a small number of components in reciprocating motion is difficult and the forces of inertia are transferred onto the system body. Those systems show an increased pressure on the guides of the component in reciprocating motion. For example, in a crank mechanism known from the Polish patent description no. PL100296, apart from some pressure of pistons on cylinders, there is increased pressure on the crank of the shaft and high rotational speeds of the gear wheel. This condition is connected to the dependency of the gear wheel diameter on the piston stroke. In addition, the manufacture of a gear wheel with internal gears, a small diameter and high speeds is difficult as such.

In the Polish patent application for an invention no. P.297432, there is a known system of gear transmissions, enabling a continuous shift of rotation ratio and torque, consisting of two epicyclic gears and a moment gear ratio, of which one is a planetary gear with a planetary gear carrier and two central wheel and the other has a geared wheel and a wheel seated on a centrally rotating arm, permanently coupled with a central wheel, which is coupled with the first wheel of the planetary gear by means of a jointed shaft. Besides, that system has two axes of torque balance, consisting of two axles in the planetary gear and an axle in the epicyclic gear.

### SUMMARY OF THE INVENTION

The purpose of this invention is to develop a new design of device with a reciprocating motion mechanism, enabling the conversion of its moment of inertia into rotational speed or rotational speed into moment of inertia, depending on the purpose, to enable capturing the energy lost during both the deceleration and the acceleration of the machine, motor or facility, in which it is installed.

The essence of this device with a reciprocating motion mechanism enabling the conversion of its moment of inertia into rotational speed or rotational speed into moment of inertia is characterised by the releasable attachment to its rotating shaft of a mechanism of reciprocating motion in two perpendicular directions, consisting of two circular discs placed next to each other in parallel, with profiled notches on their surfaces, whereby both discs have a bolted connection with each other and have a releasable connection with the rotating shaft, while between each pair of profiled notches in both discs, there are upper connectors of upper ends of each pair of moving arms placed opposite to each other. These arms have an articulated connection with each other, while their other ends also have an articulated connection with two ring connectors of two hydraulic actuators, which have a releasable connection with the shaft, whereby all upper connectors are equipped with functional components that are placed on them and have a releasable connection with them. Each of these two hydraulic actuators consists of a ring connector and a guide sleeve with a ring flange, tightly coupled using a sleeve and interconnected with bolts, evenly distributed on the perimeter of this flange and a ring connector, whereby the guide sleeve and the ring connector are float seated on the rotating shaft, on which there is an immovably and tightly seated piston, to the surface of which this sleeve tightly adheres.

It is favourable to use as functional components the components acting as belt pulley components or the components acting as cutting devices or the components acting as weights.

It is also favourable, if the rotating shaft assembly consists of the rotating shaft and fixed heads, placed tightly on both ends and supplying oil to both hydraulic actuators, whereby the rotary shaft has internal ducts tiled along its rotation axis, as well as openings perpendicular to them and connected to them made on the surface on the shaft, on both sides of fixed pistons of these actuators.

It is also favourable, if the upper connectors of the reciprocating motion mechanism have an articulated connection with the upper ends of piston rods of both electrical actuators, while the lower ends of these piston rods are connected to the ring connectors of both hydraulic actuators.

In turn, the essence of the device with the reciprocating motion mechanism enabling the conversion of its moment of inertia into rotational speed or rotational speed into moment of inertia according to the third manufacture version are characterised by its reciprocating motion mechanism is equipped with at least one circular disc and at least one hydraulic actuator that have an articulated connection with each other by means of moving arms or electrical actuators.

It is favourable if this device has measurement sensors placed on moving arms or on electrical actuators of the reciprocating motion mechanism or measurement sensors placed on the surface of the connector of this mechanism.

It is also favourable if this device has a microcontroller connected to measurement sensors and/or piston rods of electrical actuators in feedback with an additional external microcontroller connected to an oil pump.

### BRIEF DESCRIPTION OF THE DRAWINGS

FIG. 1 is a perspective side view of the device according to the present invention;

FIG. 2 is a side view of the device of FIG. 1 after the disassembly of the bearings and heads with oil ducts from its rotating shaft;

FIG. 3 is a front view of the device of FIG. 1;

FIG. 4 a cross sectional view of the device taken along line A-A in FIG. 3;

FIG. 5 a cross sectional view of the device taken along line B-B in FIG. 4;

FIG. 6 a cross sectional view of the device taken along line C-C in FIG. 4;

FIG. 7 is an enlarged detailed view of “D” of the device in axial section;

FIG. 8 is an enlarged detailed view of “E” of the device of FIG. 2;

FIG. 9 is an enlarged detailed view of “S1” shown in FIG. 3;

FIG. 10 is an enlarged detailed view of “S2” as another variant of the detail “S1” shown in FIG. 3;

FIG. 11 is an enlarged detailed view of “S3” as another variant of the detail “S1” shown in FIG. 3;

FIG. 12 shows an external microcontroller for the device according to the present invention;

FIG. 13 shows example of the use of the devices shown in FIGS. 1-11 showing the moving upper connectors shown in FIG. 9;

FIG. 14 shows an embodiment of the device shown in FIGS. 1-11, in which the guide sleeves of both actuators and upper moving connectors of the mechanism of this device have an articulated connection with each other by means of electric actuators;

FIG. 15 shows another embodiment of the device in axial section along line A-A in FIG. 2, of which the reciprocating motion mechanism consist of one left disc only; this device, which also includes the third manufacture version, is shown in FIGS. 1-5 and 8-12;

FIG. 16 shows another embodiment of the device in vertical section along line F-F; and

FIG. 17 shows an enlarged detailed view of “G” of the same version of the device in vertical section of FIG. 16.

### DETAILED DESCRIPTION OF THE INVENTION

The application in the device, based on this invention, of a mechanism equipped with two hydraulic actuators and two discs seated on a rotating shaft and the placement between these discs of upper connectors having an articulated connection with these actuators by means of arms, evenly distributed on their perimeter, enabled obtaining articulating motion in two perpendicular directions and using it for different purposes, making this device fit for multiple purposes.

Besides, this device enables the use—recovery of kinetic energy (according to the KERS system), namely the collection of the kinetic energy that is wasted under normal conditions, e.g. during vehicle braking. The mechanism based on this invention enables the storage—collection of its kinetic energy and transforming it into the power, which can be used during the start-up or acceleration, whereby the function of the flywheel in this device is fulfilled by both of its discs equipped with functional components, for example weights.

In turn, the application in the device, based on this invention, of a reciprocating motion mechanism enables a continuous change of the operating diameter of its functional components fitted to the upper connectors, surrounded for example by the flexible belt connecting the roller of a second device, as a continuously variable transmission, finds application in belt variators used in automotive gearboxes and other similar devices.

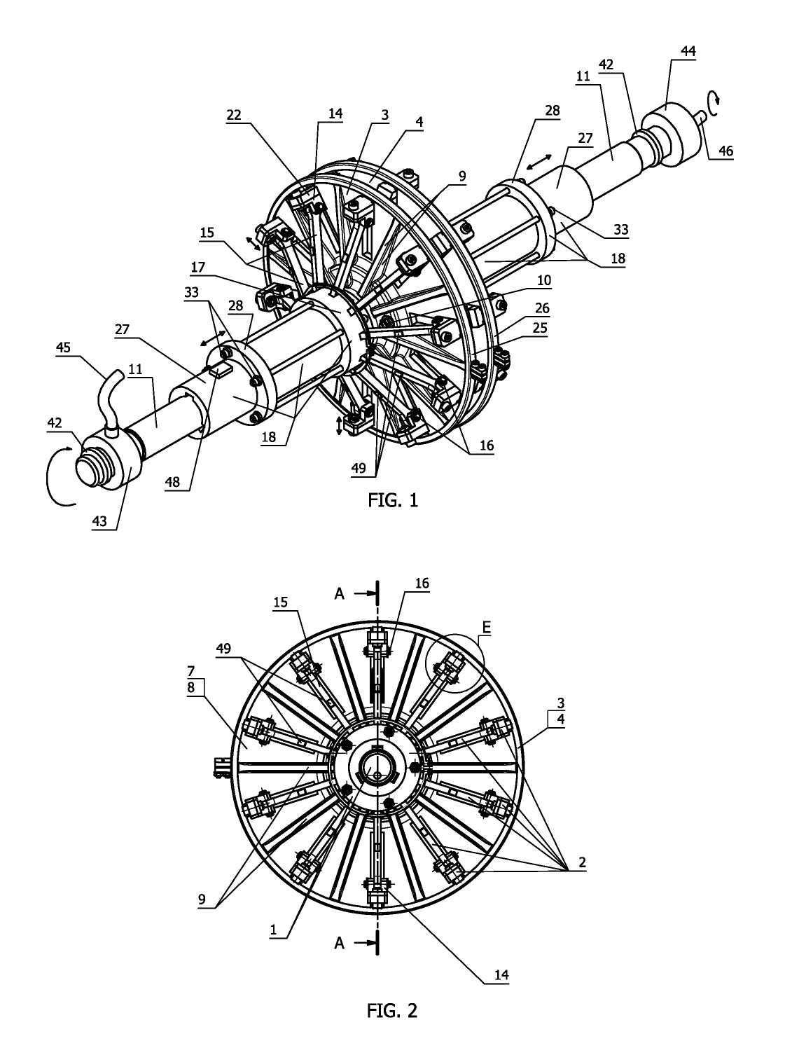

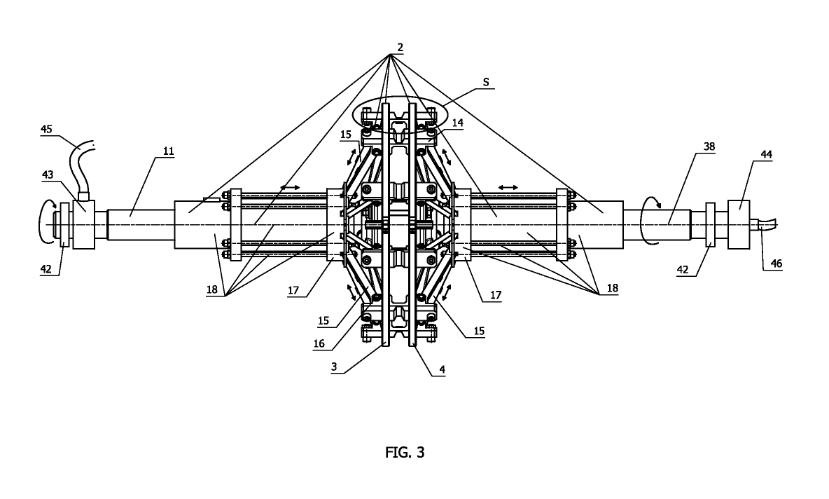

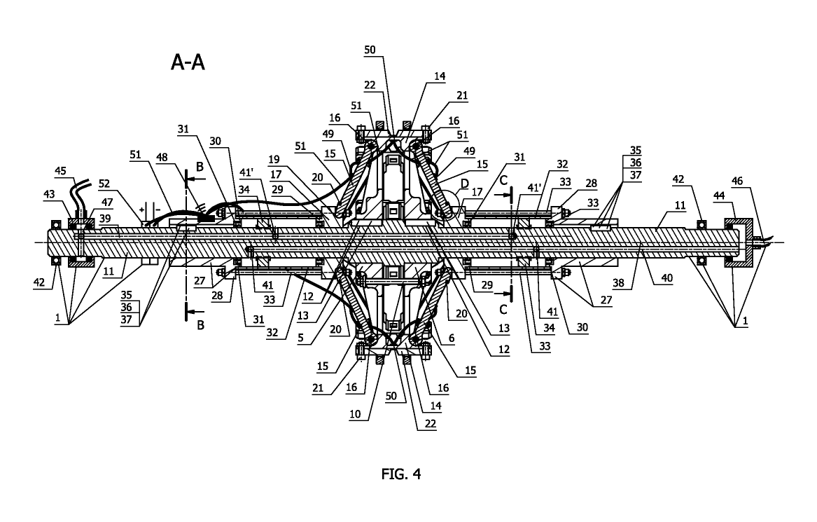

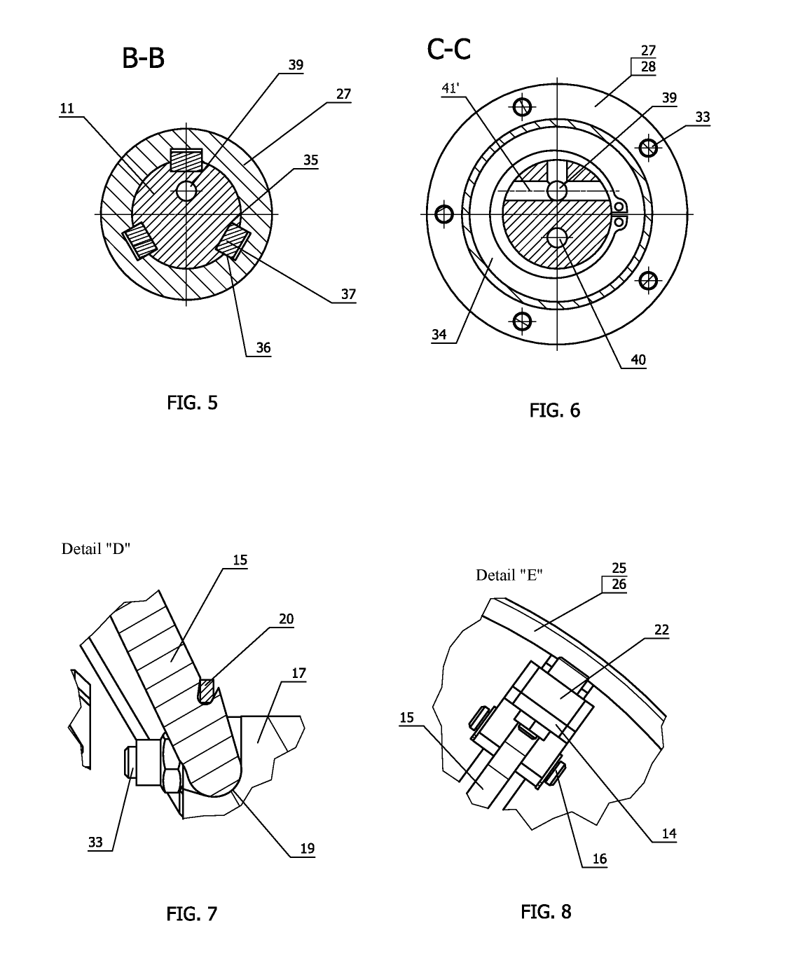

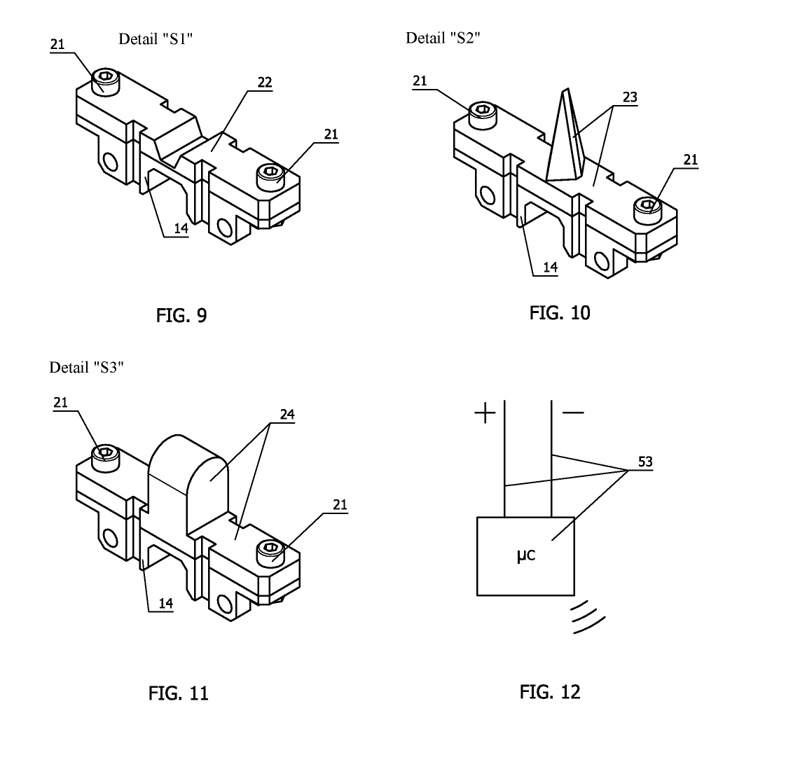

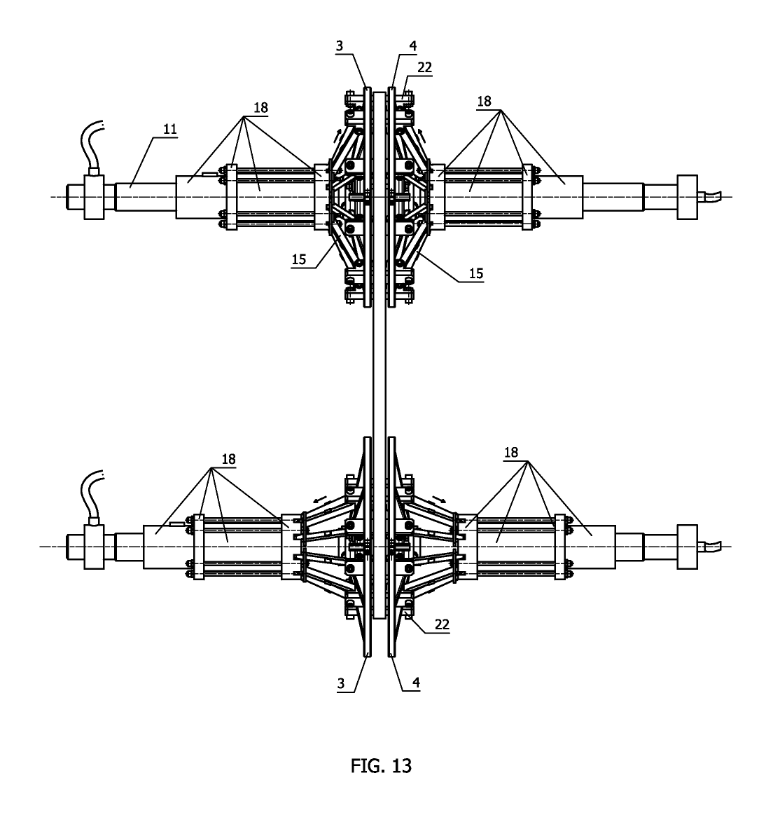

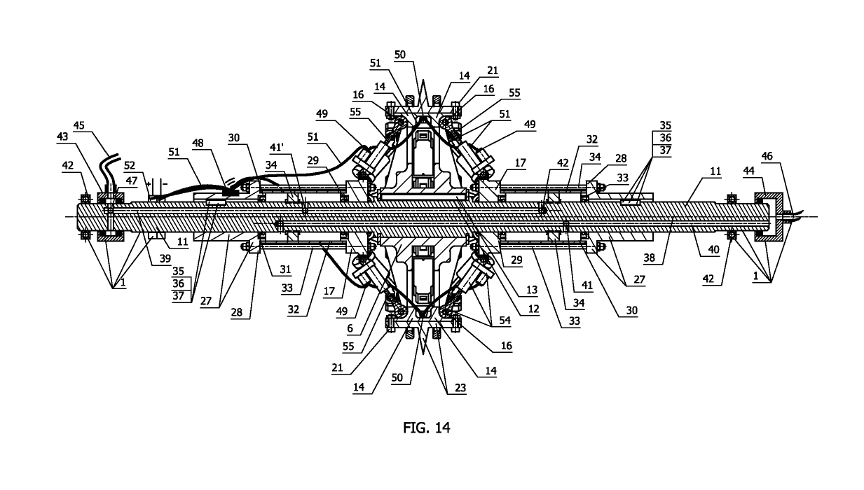

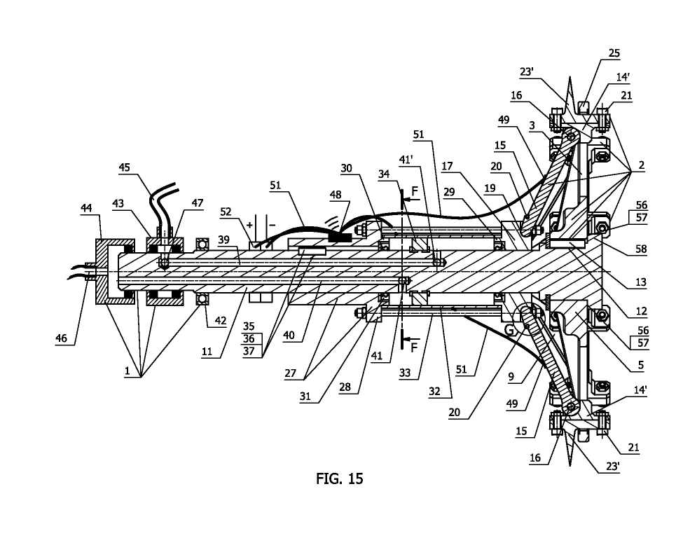

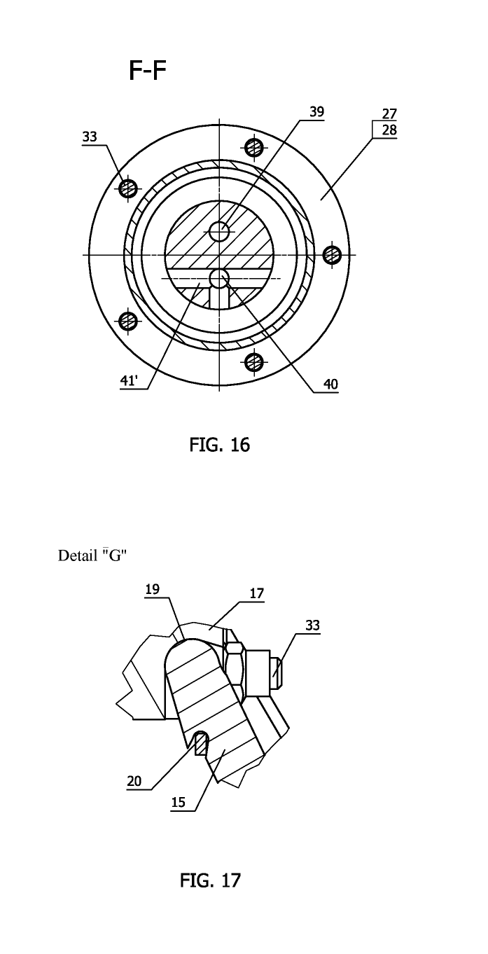

The subject of this invention in the three basic manufacture versions is shown in the drawing, in which FIGS. 1-11 the first manufacture version of the device with a reciprocating motion mechanism enabling the conversion of its moment of inertia into rotational speed or rotational speed into moment of inertia, in which the guide sleeves of both actuators have an articulated connection by means of rigid guide arms with moving upper connectors, whereby FIG. 1 shows this device in 3D view, FIG. 2—the same device in side view, after the disassembly of the bearings and heads with oil ducts from its rotating shaft, FIG. 3—the same device in front view, FIG. 4—the same device in axial section along line A-A, FIG. 5—the same device in cross section along line B-B, FIG. 6—the same device in cross section along line C-C, FIG. 7—augmented detail “D” of the device in axial section, FIG. 8—augmented detail “E” of the device in side view, FIG. 9—detail “S1” shown in FIG. 3 of the upper connector of the arms of the motion mechanism of this device, connected to a functional component equipped with a trapezoid duct, in 3D view, FIG. 10—detail “S2” as another variant of the detail “S1” shown in FIG. 3 of the upper connector of the arms of the motion mechanism of this device, also connected to a functional component, but equipped with a cutting tool, in 3D view, FIG. 11—detail “S3” as another variant of the detail “S1” shown in FIG. 3 of the upper connector of the arms of the motion mechanism of this device, also connected to a functional component, but equipped with a weight component (weight) in 3D view, FIG. 12—external microcontroller, FIG. 13 example use of the two devices shown in FIG. 1-11, equipped with the moving upper connectors shown in FIG. 9, for making a variator, FIG. 14—the second manufacture version of the device shown in FIG. 1-11, in which the guide sleeves of both actuators and upper moving connectors of the mechanism of this device have an articulated connection with each other by means of electric actuators, FIG. 15—the third manufacture version of the device in axial section along line A-A in FIG. 2, of which the reciprocating motion mechanism consist of one left disc only; this device, which also includes the third manufacture version, is shown in FIGS. 1-5 and 8-12, FIG. 16—the third manufacture version of this device in vertical section along line F-F, and FIG. 17—augmented detail “G” of the same version of the device in vertical section.

The device with a reciprocating motion mechanism enabling the conversion of its moment of inertia into rotational speed or rotational speed into moment of inertia according to the first manufacture version, as shown in FIG. 1-11, consists of the rotating shaft assembly 1 and the installed on it mechanism of reciprocating motion in two perpendicular directions 2. The mechanism of this motion consists of two circular discs 3 and 4 with hubs 5 and 6, tiled in parallel, of which the surfaces have 10 trapezoid notches 7 and 8 each, with two rounded sides, also separated by 10 stiffening ribs 9, made in each of the two discs and placed opposite to each other, whereby both hubs 5 and 6 of these discs are connected by means of bolts 10 and fixed to the rotating shaft 11 by means of grooves 12 in this shaft and in discs 3 and 4, and tongues 13 seated in them. Between each pair of trapezoid notches 7 and 8, there are connectors 14 of the upper ends of each pair of opposite moving arms 15, having an articulated connection with each other by means of pins 16, while the other ends of these arms are connected to two ring connectors 17 of two hydraulic actuators 18 by means of seating in profile notches 19 of each pair of these connectors and connecting them with each other using clamping rings 20, whereby all connectors 14 are equipped functional components 22, acting as a belt pulley, or functional components 23, acting as a cutting tool, a knife or a cutter, or functional components 24, acting as a weight, placed on them and connected to them by means of bolts 21. In addition, the external upper surfaces of both circular discs 3 and 4 are covered by ring guards 25 and 26. Each of the two hydraulic actuators 18 of the reciprocating motion mechanism 2 consists of a ring connector 17, a guide sleeve 27 with ring flange 28, which are float seated on the rotating shaft 11, whose opposite surfaces have recesses 29 and 30 with seals 31 between them and the shaft, whereby both of these recesses contain sleeve 32, of which both faces adhere to this connector and flange, which are connected to each other by means of 5 bolts 33, evenly distributed on their perimeter. In addition, a fixed ring piston 34 is seated and sealed on the rotating shaft 11. The external surface of this piston is flush with the internal surface of the sleeve 32 of this actuator, however both on the external surface of this shaft and on the internal surface of the guide sleeve 27 there are three guide ducts 35, evenly distributed on their perimeters, with containing grooves 36, which are also seated inside corresponding grooves 37 on the rotating shaft 11, enabling simultaneous sliding coaxial reciprocating movement of both hydraulic actuators 18.

In turn, the rotating shaft assembly 1 consists of the rotating shaft 11, having two internal ducts 39 and 40 along its rotation axis 38, and their perpendicular and connected openings 41 and 41′, made on the surface of this shaft and placed under sleeves 32 and on the opposite sides of pistons 34 of hydraulic actuators 18, whereby on both ends of the rotating shaft there are seated rolling bearings 42, and besides them there are fixed sealed heads 43 and 44 with external oil ducts 45 and 46, which supply pressurised oil to both actuators through the vertical opening 47 connected to the duct 39 or directly through the duct 40. In addition, a microcontroller 48 is seated on the external surface of the guide sleeve 27 of the hydraulic actuator 18, and sensors 49 and 50 are on the surface of upper connectors 14 and moving arms 15 of the reciprocating motion mechanism, or favourably strain gauges for force measurement, which are connected to the electrical power source 52 by means of electrical wires 51.

In addition, the device based on the invention is equipped with an external microcontroller 53, in wireless co-operation with the microcontroller 48 by means of electromagnetic waves.

The device with a reciprocating motion mechanism enabling the conversion of its moment of inertia into rotational speed or rotational speed into moment of inertia according to the second manufacture version, as shown in FIG. 14, has a similar design to the device according to the first manufacture version (FIG. 1-11), and the difference between them consists only in the replacement of the rigid arms 15 of the first version with electrical actuators 54, also having an articulated connection with the connectors 14, in which the upper ends of piston rods 55 have an articulated connection by means of pins 16 with their connectors 14, while the lower ends of these piston rods are connected to two ring connectors 17 of the two hydraulic actuators 18.

In turn, the device with a reciprocating motion mechanism enabling the conversion of its moment of inertia into rotational speed or rotational speed into moment of inertia according to the third manufacture version, as shown in FIG. 15 FIG. 17 has a similar design to the device according to the first version, as shown in FIG. 1-5 and FIG. 8-11, and the difference between them consists only in the third version including only the left half of the device according to the first version, with the left disc 3 being equipped with all existing components co-operating with it. Due to this restriction, the device with a reciprocating motion mechanism enabling the conversion of its moment of inertia into rotational speed or rotational speed into moment of inertia according to the third manufacture version, as shown in FIG. 15-17, also consists of the rotating shaft assembly 1 and the installed on it mechanism of reciprocating motion in two perpendicular directions 2. The mechanism of this motion also consists of only one circular disc 3 with hub 5, of which the surface has 10 trapezoid notches 7, with two rounded sides, separated by 10 stiffening ribs 9, made in this disc, whereby the hub 5 of this disc is fixed to the rotating shaft 11 by means of grooves 12 in it and tongues 13 seated in them, whereby the external surface 56 of this disc adheres to the external surface 57 of the ring recess 58 of the rotating shaft 11. In each trapezoid notch 7 of the disc 3, moving arms 15 are placed, of which the upper ends have an articulated connection by means of pins 16 with connectors 14′, while the lower ends of these arms are connected to the ring connectors 17 of the hydraulic actuator 18 by means of seating in profile notches 19 and using clamping rings 20, while all upper connectors 14′ are equipped with functional components 23′, acting as a cutting tool, or a belt pulley 22, or weight 24, placed on them and connected to them by means of bolts 21. In addition, the upper external surface of the disc 3 is covered by a ring guard 25. In turn, the hydraulic actuator 18 of this device also consists of a ring connector 17, a guide sleeve 27 with ring flange 28, which are float seated on the rotating shaft 11, whose opposite surfaces have recesses 29 and 30 with seals 31 between them and the shaft, whereby both of these recesses contain sleeve 32, of which both faces adhere to this connector and flange, which are connected to each other by means of bolts 33, evenly distributed on their perimeter. In addition, a fixed ring piston 34 is seated and sealed on the rotating shaft 11. The external surface of this piston is flush with the internal surface of the sleeve 32 of this actuator, however both on the external surface of this shaft and on the internal surface of the guide sleeve 27 there are three guide ducts 35, evenly distributed on their perimeters, with containing grooves 36, which are also seated inside corresponding grooves 37 on the rotating shaft 11, enabling simultaneous sliding coaxial reciprocating movement of this actuator. Besides, in this version of the device the rotating shaft assembly 1 consists of the rotating shaft 11, having an internal duct along its axis 39 and a second duct 40 in the head of the shaft, parallel to the channel 39. The internal ends of these openings are connected by perpendicular openings 41 and 41′, also made in the rotating shaft 11 with the inside of the guide sleeve 27 of the hydraulic actuator 18, whereby one of these openings is on one side of the piston 34 of this actuator and the other on the opposite side of this piston. In addition, on the free end of the rotating shaft 11 there is a seated rolling bearing 42 with a fixed sealed head 44 covering its head, while both of these heads are equipped with external oil ducts 45 and 46, which supply pressurised oil to this actuator through the opening 47 to the duct 39 or directly through the channel 40. In addition, in this version of the device as well, a microcontroller 48 is seated on the external surface of the guide sleeve 27 of the hydraulic actuator 18, and sensors 49 are on the surface of moving arms 15 of the reciprocating motion mechanism, or favourably strain gauges for force measurement, which are connected to the electrical power source 52 by means of electrical wires 51.

The working principle of the first or the second version of the device based on this invention consists in supplying the oil using external ducts 45 and 46 to the control heads 43 and 44, from which it is supplied to the sleeve 32 under specific pressure through duct 39 and opening 41′ made in the rotating shaft 11, which results in the hydraulic actuators 18 of the motion mechanism 2 using their guide sleeves 27 making a horizontal plane motion towards towards both discs 3 and 4, which results in the arms 15, which have an articulated connection with them, moving with the interconnecting upper connectors 14 and functional components 22 or 23 or 24 towards the guards 25 and 26 of both discs 3 and 4 to their maximum position, limited by the length of arms 15, which sets their maximum diameter. In turn, if oil is supplied to the sleeve 32 of both hydraulic actuators 18 through the duct 40 and the opening 41, the plane motion of these actuators switches to the opposite direction, which results in the arms 15 of the motion mechanism 2 moving towards the rotation axis 38 of the rotating shaft 11 to their set position, which at the same time causes a vertical, inverse motion of the upper connectors 14 with their functional components 22 or 23 or 24, which sets their minimum diameter. The working principle of the third version of the device based on this invention is also similar to the above described working principle of the first and second manufacture version.

The switch of direction of the horizontal reciprocating motion of both hydraulic actuators 18, resulting in a corresponding change of direction of the vertical reciprocating motion of upper connectors 14 with their functional components 22 or 23 or 24, causes as appropriate the conversion of the moment of inertia into rotational speed or rotational speed into moment of inertia, triggered by the change of diameter of these connectors and their functional components.

In turn, the microcontroller 48 is supplied from an external electrical power source, for example, a battery, whereby the voltage of this current is transmitted by the rotating shaft 11, for example by graphite brushes, not shown in the drawing, transferring the voltage to the sliding sleeves placed on this shaft. Sensors 49, for example strain gauges, are used to measure the strain and force of the torque, while sensors 50 are used to measure the load of the upper connector 14. In turn, the external microcontroller 53 is used for wireless communication (radio, for example Bluetooth) with the controller 48, placed on the rotating shaft 11, thus it is used to:

download the acquired data from the microcontroller 48 and sensors 49 and 50

send signals to the microcontroller 48 to control electrical actuators 54, changing the length of their piston rods 55, as well as to:

measure the rotational speed by means of a sensor, not shown in the drawing

control the pump (not shown in the drawing), supplying oil through heads 44 and 45, thus to control the position of hydraulic actuators 18 during the reciprocating motion.

### LIST OF REFERENCES IN THE FIGURES FIGS.

1—drive shaft assembly

2—reciprocating motion mechanism

3—disc of the mechanism

4—disc of the mechanism

5—hub of the disc

6—hub of the disc

7—trapezoid notches in the disc

8—trapezoid notches in the disc

9—stiffening ribs of the disc

10—bolts connecting the discs

11—rotating shaft

12—grooves on the rotating shaft and disc

13—connecting tongues

14—upper connectors of both discs and moving arms

15—moving arms

16—pins

17—ring connectors of hydraulic actuators

18—hydraulic actuators

19—profiled notches in lower ends of the arms

20—clamping rings

21—bolts connecting upper connectors to functional components

22—functional components acting as a belt pulley

23—functional components acting as a cutting tool

24—functional components acting as a weight

25—ring guard of the disc

26—ring guard of the disc

27—guide sleeves of actuators

28—ring flanges of guide sleeves

29—recess of the ring connector

30—notch of the ring flange of the guide sleeve

31—seals

32—sleeves of actuators

33—bolts connecting connectors and flanges of guide sleeves

34—actuator pistons

35—guide ducts

36—connecting grooves

37—grooves for tongues in the shaft 11

38—rotation axis of the rotating shaft

39—duct inside the rotating shaft

40—duct inside the rotating shaft

40 and 41′—transverse openings on the shaft surface

42—bearings on the rotating shaft

43—head supplying compressed oil

44—head supplying compressed oil

45—oil duct

46—oil duct

47—vertical opening connected to horizontal opening

48—microcontroller

49—sensor

50—sensor

51—electrical wires

52—electrical power source

53—external microcontroller

54—electrical actuators

55—ends of piston rods

56—external surface of the disc

57—external surface of the ring recess of the actuator

58—ring recess of the rotating shaft

1. A device with a reciprocating motion mechanism to enable a conversion of a moment of inertia into a rotational speed or rotational speed into moment of inertia, the device comprising:
a rotating shaft, the rotating shaft (11) includes is a releasable mechanism (2) of reciprocating motion in two perpendicular directions, the release mechanism (2) includes of two circular discs (3 and 4), tiled in parallel, with profiled notches (7 and 8) on their surfaces, whereby the two circular discs are connected with each other by bolts (10) and have a releasable connection with the rotating shaft (11) and between each pair of the profiled notches (7 and 8) of the two circular discs there are upper connectors (14) on upper ends of each pair of opposite moving arms (15), having an articulated connection with each other, the other ends also have an articulated connection with the two ring connectors (17) of two hydraulic actuators (18), which have a releasable connection with the shaft, whereby all upper connectors are equipped with functional components (22) placed on them and having a releasable connection with them.

2. The device according to claim 1, wherein each of the two hydraulic actuators (18) includes a ring connector (17) and a guide sleeve (27) with a ring flange (28), tightly coupled using a sleeve (32) and interconnected with bolts (33), evenly distributed on the perimeter of the flange and the ring connector (17), whereby the guide sleeve (27) and the ring connector (17) are float seated on the rotating shaft (11), on which there is an immovably and tightly seated piston (34), to the surface of which the sleeve tightly adheres (32).

3. The device according to claim 1, wherein the functional components (22) act is a belt pulley.

4. The device according to claim 1, the functional components (22) functional is a cutting devices.

5. The device according to claim 1, wherein the functional components (22) are weights.

6. The device according to claim 1, wherein the rotating shaft assembly (1) includes a rotating shaft (11) and fixed heads (43 and 44), placed tightly on both ends and supplying oil to both hydraulic actuators (18), whereby the rotary shaft (11) has internal ducts (39 and 40) tiled along a rotation axis (38), an openings (41 and 41′) perpendicular to the internal ducts and connected to them made on the surface on the shaft, on both sides of fixed pistons (34) of these actuators.

7. The device according to claim 1, wherein the upper connectors (14) of the reciprocating motion mechanism (2) have an articulated connection with the upper ends of piston rods (55) of electrical actuators (54), while the lower ends of these piston rods are connected to the ring connectors (17) of both hydraulic actuators (18).

8. The device according to claim 1, wherein the reciprocating motion mechanism (2) is equipped with at least one circular disc (3 or 4) and at least one hydraulic actuator (18), which have an articulated connection by arms (15) or electrical actuators (54).

9. The device according to claim 1 wherein the device further includes measurement sensors (49) placed on moving arms (15) or on the electrical actuators (54) of the reciprocating motion mechanism (2) or measurement sensors (50) placed on the surface of the connector (14).

10. The device according to claim 9 wherein the device further includes a microcontroller (48) connected with measurement sensors (49) and (50) and/or piston rods (55) of electrical actuators (54) in feedback with an additional external microcontroller (53), connected with an oil pump.
